(19) United States
(12) Patent Application Publication
(10) Pub. No.: US 2009/0298532 A1
(43) Pub. Date: Dec. 3, 2009

(54) SYSTEM FOR CARRYING OUT A DATA TRANSFER AND COMPONENTS OF SAID SYSTEM

(76) Inventor: Wolfgang Richter, Starmberg (DE)

Correspondence Address: K.F. ROSS P.C., 5683 RIVERDALE AVENUE, SUITE 203 BOX 900, BRONX, NY, 10471-0900, US

(21) Appl. No.: 12/097,065

(22) PCT Filed: Dec. 12, 2006
(86) PCT No.: PCT/EP06/11944

§ 371 Date: Oct. 23, 2008

(30) Foreign Application Priority Data
Dec. 21, 2005 (DE) 10 2005 059 149.3

(51) Int. Cl. H04M 1/00

(52) U.S. Cl. 455/556.1

(57) ABSTRACT

The invention relates to a system for carrying out a data transfer and to components of said system. The invention also relates to a method for coordinating data transfer operations and for generating, processing and making other modifications to data. The invention relates in particular to data transfer operations that can be carried out in conjunction with one another using an authorisation request or value date operation. The aim of the invention is to provide solutions that permit data transfer operations to be carried out in the environment of a user in an improved manner compared to current concepts. This is achieved by a communication system comprising: a mobile component on the user side containing a transmitter and a receiver for transmitting and receiving data within a mobile radio network; a complementary system that is also implemented on the user side for providing functional data relevant to the operation of the mobile component; and a transfer system for achieving a coupling of the mobile component and the complementary system that permits signal transmission. Said transfer system comprises a first interface element, assigned to the mobile component and a second interface element, assigned to the complementary system and cc is designed in such a way that signal transmission takes place on the basis of electric-field interactive effects.

The invention relates to a system for transferring data and the components of such a system. The invention further relates to a method for the coordination of data transfer operations as well as for generating, processing, and making other modifications to data. The invention relates in particular to data transfer operations that can be carried out in conjunction with one another using an authorization request or a validation operation.

The object of the invention is to provide solutions that permit data transfer operations to be carried out in the immediate surroundings of a user in an improved manner compared to other concepts.

This object is attained according to the invention by means of a communications system including:
a mobile unit carried by the user and containing a transmitter and a receiver for transmitting and receiving data within a mobile communications network,
a complementary system that is also implemented carried by the user for providing functional data that are relevant per se to the operation of the mobile unit, and
a transfer system for coupling the mobile unit for signal transmission with the complementary system,
the transfer system including a first interface assigned to the mobile unit and a second interface assigned to the complementary system, the transfer system also being embodied in such a way that signal transmission occurs on the basis of electric field interactive effects.

Thus, it becomes possible in an advantageous manner for a data navigator to be created using the complementary system by means of which data necessary for its functioning or to operate other communication or data transfer systems may be made available according to a differently specified concept. These different communications or data transfer systems may then be realized with a reduced circuitry expense.

The concept according to the invention is particularly appropriate for a system in which the first interface is integrated into the mobile unit, for example, a cell phone. The first interface may be integrated into or docked on a SIM card. It may be docked on a SIM card in that the near-field circuit is integrated into a SIM card connector.

The first interface may also be integrated into the electronic circuitry of a cell phone per se. Moreover, it is possible for the first interface to be coupled with an interface of the cell phone. It is possible for the second interface to be included in an accessory component of the mobile phone, for example, an upgrade battery. This results in a relatively large amount of available space for the circuit of the first interface, a simple power supply, and a large area for the signal electrode. Here, the structures of the battery may in particular function as a signal electrode.

The second interface is preferably integrated directly into the complementary system. It is also possible for the second interface system to be integrated into an interface of the complementary system. The complementary system may be embodied by a Game Boy or some other convenient communication system. The corresponding configuration of the Game Boy may be made possible by an insert equipped with the circuit according to the invention and forming the second interface.

It is possible for the entire system to be configured in such a way that the functionally ready state of the mobile units is created by signals provided by the complementary system.

Typically, speech is recorded and/or played back by using the mobile unit that is ergonomically designed for this purpose. Alternately or as an additional functional variant, it is also possible for speech to be recorded and/or played back by using the complementary system. The mobile unit equipped with the first interface may then essentially be reduced to handling cell phone conversations in accordance with its function.

It is possible to set a system configuration via the complimentary system. The complementary system may be used to configure the appearance profile of the data provided via the complementary system. Thus, it is possible to couple a USB stick or some other mobile compact data storage device with a first interface and thus to create a system in which viewing the data content of the USB stick or some other mobile storage device is only allowed if permitted by the complementary system. This manner of accessing data may be coordinated via the complementary system. Thus, it is possible to dynamically determine the release of directories on the USB stick via the complementary system.

According to a particularly advantageous embodiment of the invention, access data for various network systems may be viewed via the complementary system. Thus, it is possible to conduct a simultaneous dial-in into multiple networks with only one mobile communications system.

The complementary system may be embodied in such a way that it includes a LAN interface. Thus, it becomes possible to connect to network systems, in particular to the Internet, and to implement cost-effective VoIP communication via the connected cell phone.

In the region of the complementary system, a cell phone device, in particular a GPRS interface, may be provided for further expanding the communication options. Using the complementary system, the mobile unit may be used as an input system for VoIP communication.

It is possible for the complementary system to be structured in such a way that data may be retrieved via this complementary system or the second interface system that provide information regarding the physiological condition of the user.

The invention is particularly suitable for cell phones and communications instruments in the low-cost market, for example, disposable cell phones. These single-use telephones may be used by the authorized user in a simple manner using the technology according to the invention with low setup costs. It is possible for the integration of a SIM card system into a cell phone, which has been customary up to now, to be omitted. The corresponding data may be accessed and, if necessary, navigated via a universal authorization system. Thus, particularly data regarding access authorizations, personal telephone numbers, and other data may be accessed via the user-specific complementary system. Thus, it becomes possible for an operator or user to have such a card separately in his or her possession and make these data accessible to the mobile phone the operator or user is currently using. This becomes possible when the cell phone as well as the access card (SIM) near the user and also in use.

Another complementary device carried along in the form of a receiver, for example, a key chain, wallet, belt clip, etc. (jewelry, clothing), may accommodate the known SIM card and/or additional storage devices such a memory sticks, flash cards, etc.

In addition to the receiver, the complementary device has a communication device that works two ways. On the one hand, a connection with a cell phone currently in physical contact with the user may be established via the user's skin if the telephone in question is equipped with a similar communication device; on the other hand, the communication device may also receive, process, and optionally transmit to the cell phone signals from the outside world. This is often associated with data servers (for example, GPRS), such that, due to objects being in contact, data communication is able to occur via the receiver and the cell phone in contact with a server station (routing). When a telephone is touched, the authorization number of the SIM card inserted in the communication device is sent to the cell phone. It is possible for additional authorization (biometric data, PIN codes, etc.) to occur as well. The cell phone may lock automatically when it is put down. Therefore, it is possible for the cell phone to be assigned to a certain user who will be the only person able to operate it. It is also possible for anyone to be allowed to operate the cell phone who touches it and who has an approved authorization on his or her person (personal SIM). This may be achieved by a simple functional design. It is also possible for the cell phone to automatically switch to hands-free mode when the cell phone is set down. This may be advisable, for example, if the cell phone is being used in a motor vehicle or in a conference. A call is received as usual, then the telephone is set down and the communication device ensures—by virtue of the fact that the connection to the body is no longer present—that an automatic hands-free device is activated. If the telephone is not in contact with the user's body, it may be briefly touched in order to receive calls via the hands-free device. The telephone is automatically locked for unauthorized persons; therefore, theft of the telephone is pointless.

The invention is also suitable for other telephones (for example, telephone booths and hotels, DECT, etc.). It is possible for external communication to be conducted via a known or new wireless system or even via touch. For this purpose, code transmitters may be attached to certain objects, for example, products. Upon being touched, they send a code via the user's skin to the communication device. The communication device verifies in turn whether the code contains a permitted data format (CRM filter), in order to then show information about this object on the cell phone from the server. This feature shall be referred to below as “skin routing.” The invention allows an ambient behavior of electronic systems (human-machine interface) and allows an object to be used by a person and for the object to be matched with external memory and data processing devices (servers) via the communication device.

It is also possible for the receiver to supply data that originate from scanners, touched price tags, local base services, medical and health-related devices, and navigation inside and outside of motor vehicles. In addition, an RFID laser may be assigned to the receiver according to the invention, as well as a device for indicating calls. By omitting expensive components in the cell phone, the cell phone becomes less expensive to produce and distribute.

The body communication unit associated with the cell phone may also be inserted in a cell phone in the form of a conventional SIM card while the user-oriented SIM card is located in the receiver according to the invention.

Adapting the invention to conventional memory cards (flash, CF, SD, etc.) is also possible. Thus, the invention may also be used for PDA's and portable navigation and entertainment devices (PSP, Game Boy).

A telephone equipped with the communication device according to the invention may also make the speed-dial numbers that are normally stored on SIM cards available to the currently authorized user who is carrying such a communication device and has touched or desires to use a telephony device equipped in such a fashion.

It is possible for data, for example, music signals or ring tones, to be archived from the cell phone signal as long as the cell phone is held in the user's hand. Used cell phones may then be disposed of in a simple manner since they no longer contain any personal data according to the invention. By virtue of the simplified authorization processes, it is possible for an additional personal code (P code) to be supplied that, upon contact with an object, for example, a cell phone, equipped with the communication device according to the invention, transmits this code to the device and unlocks functions if the authorization check is successful.

Regarding the physical background of the near-field technology used according to the invention, we hereby refer to patent applications already published, in particular in the name of the present applicant, and the prior art identified therein. In this near-field technology, an electrical field is generated by means of an electrode device. This field is modulated according to the requirements of a data pattern, the modulation frequency lies in a frequency range in which the field effects are, to a large extent, still in accordance with the principles of static fields. No grounding occurs from the electrode to the user, but rather only a charge distortion that weakens sharply at the edge of the near-field range. This charge distortion may also be detected by a receiving system also having an electrode. The actually disadvantageous effect of the short range of the near field is solved by the technology according to the invention, which ensures that the signal transmitted by the complementary components may be used only in the immediate area of the user. Communication between the interfaces may occur only on the basis of encryption processes.

Additional details and features of the invention may be found in the description below in conjunction with the drawings, in which:

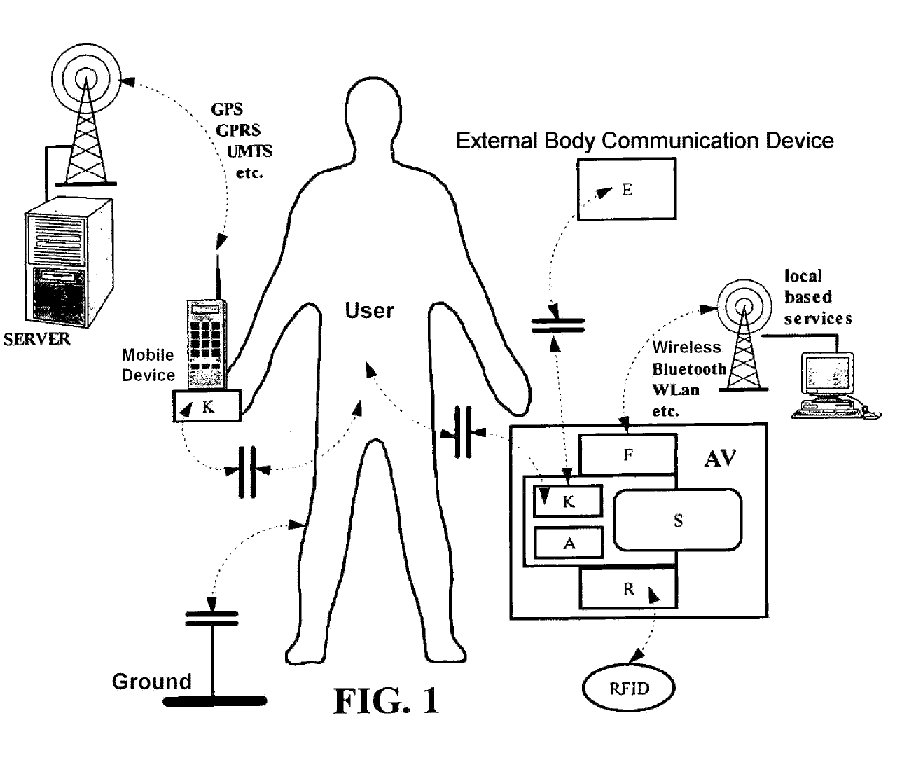

FIG. 1 is a schematic view showing the concept according to the invention;

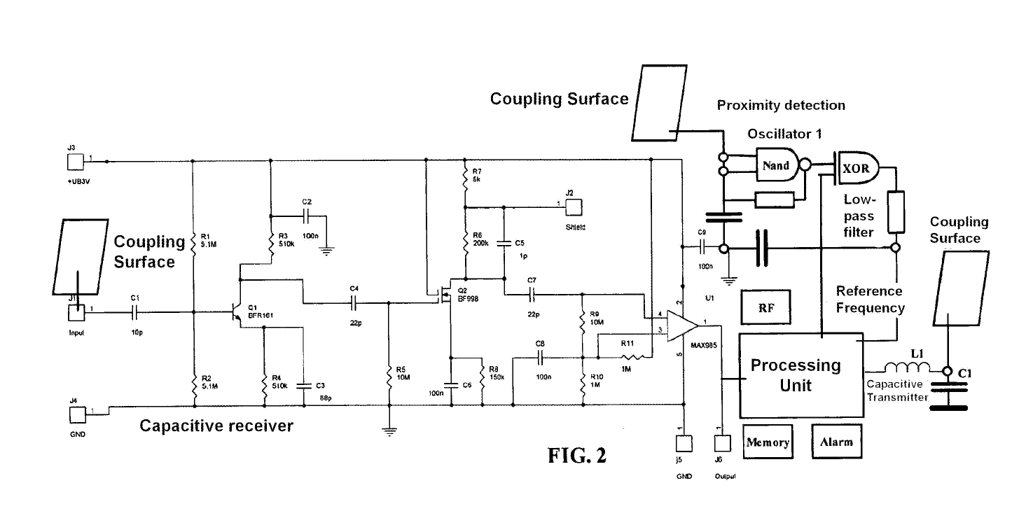

FIG. 2 is a circuit diagram illustrating the circuit structure of the system according to the invention.

FIG. 1 shows a schematic view of a communication system containing the components according to the invention whose structure includes the user. The system includes a mobile unit, for example, in the form of a cell phone, and a complementary component, for example, in the form of another cell phone, a PDA, or a Game Boy. Both components are in a near-field signal connection. The counterpart to the first interface may be found in the receiver AV. In the receiver, the wireless transceiver F for connecting to so-called “local-based services” is present, as well as a read/write device for the transponder chip RFID. External accessory devices may communicate with the receiver AV and/or the mobile device using their own body-based communication device E. An alarm A may be added to the receiver. Other components such as alarms, mp3 players, cameras, etc. may also be stored in the housing of the receiver.

The mobile device (for example, cell phone) as well as the receiver AV according to the invention, in which the SIM/memory card S is located are able to “recognize” whether they are near the body of a user because his or her capacity against the ground forms a voltage divider, which may be detected and advantageously used in various manners. Thus, the invention may first behave in a manner similar to a capacitive proximity sensor and, in so doing, recognize whether it is being carried by a user (automatic activation).

By means of the system according to the invention, it becomes possible in particular for the functionality of a cell phone to be coordinated according to the requirements of configuration concepts and data that are held in readiness and, optionally, modified.

### An Exemplary Circuit Design

FIG. 2 shows a complete circuit according to the invention. The are amplified by an electrode connected at the input via a pre-amplifier comprised of Q1 and Q2 and sent to a processor (microprocessor, FPGA, DSP, DSC, ASIC, etc.) via a comparator of an evaluation software, which processor is also able to impress data modulated in series resonance on the skin surface of a user via L1 and C1. The detuning of the inverter oscillator Osz. 1 generates proximity detection via a mixer XOR with a low-pass filter located downstream. Finally, the above-described processor also manages inserted (or internal) memory media (SIM card, FD, SD, MMC, memory stick, etc.). In addition, various wireless modules/RFID readers and other electronic components may be connected to and operated by the system.

1. A communications system having:
a mobile unit carried by the user containing a transmitter and a receiver for transmitting and receiving data within a mobile communications network,
a complementary system that is also implemented carried by the user for providing functional data that are relevant per se to the operation or function of the mobile unit, and
a transfer system for achieving a coupling that permits signal transmission of the mobile unit with the complementary system,
the transfer system including a first interface assigned to the mobile unit and a second interface that is assigned to the complementary system, the transfer system also being embodied in such a way that signal transmission occurs on the basis of electric field interactive effects.

2. The communications system according to claim 1, wherein the first interface is integrated into the mobile units.

3. The communications system according to claim 1 wherein the mobile unit is a cell phone.

4. The communications system according to claim 1 wherein the first interface is integrated into a SIM card.

5. The communications system according to claim 1 wherein the first interface is integrated into a SIM card connector.

6. The communications system according to claim 1 wherein the first interface is integrated into a cell-phone component.

7. The communications system according to claim 1 wherein the first interface is integrated into the electronic circuitry of the cell phone.

8. The communications system according to claim 1 wherein the first interface is coupled with an interface of the cell phone.

9. The communications system according to claim 1 wherein the second interface is integrated into the complementary system.

10. The communications system according to claim 1 wherein the second interface system is coupled with an interface of the complementary system.

11. The communications system according to claim 1 wherein the complementary system is a data-processing system.

12. The communications system according to claim 1 wherein the complementary system is a Game Boy.

13. The communications system according to claim 1 wherein the second interface system is embodied as a Game Boy cartridge.

14. The communications system according to claim 1 wherein the functional readiness of the mobile units is supplied by signals provided by the complementary system.

15. The communications system according to claim 1 wherein the mobile units may be used for the recording and/or playback of speech.

16. The communications system according to claim 1 wherein the complementary system may be used for the recording and/or playback of speech.

17. The communications system according to claim 1 wherein a system configuration may be accomplished via the complementary system.

18. The communications system according to claim 1 wherein the appearance profile of the data accessed via the complementary system may be configured by means of the complementary system.

19. The communications system according to claim 1 wherein access data for various network systems may be accessed via the complementary system.

20. The communications system according to claim 1 wherein balance data may be accessed via the complementary system.

21. The communications system according to claim 1 wherein the complementary system includes a LAN interface.

22. The communications system according to claim 1 wherein a mobile wireless unit, in particular a GPRS interface, is provided in the region of the complementary system.

23. The communications system according to claim 1 wherein the mobile unit may be used as a VoIP input system via the complementary system.

24. The communications system according to claim 1 wherein data may be injected via the complementary system or the second interface system that provide information on the physiological state of the user.

25. A first interface for a communications system of the type described in claim 1.

26. A second interface for a communications system of the type described in claim 1.

27. A marketable unit for the system of claim 1 and composed of the first interface and the second interface.

28. The unit according to claim 27 wherein both interfaces are provided with a coding that allows encrypted communication between these elements.

29. The unit according to claim 27 or 28 wherein both interfaces are embodied as SIM card structures, both of which are integrated into a card frame and may be separated therefrom.
